(19) United States
(12) Patent Application Publication
(10) Pub. No.: US 2023/0160561 A1
(43) Pub. Date: May 25, 2023

(54) Tree Lights Hanger Tool

(71) Applicant: Sylvia June Lewis, Miamisburg, OH (US)

(72) Inventor: Sylvia June Lewis, Miamisburg, OH (US)

(21) Appl. No.: 17/533,109

(22) Filed: Nov. 23, 2021

(51) Int. Cl. F21V 21/00; A47G 33/10

(52) U.S. Cl. CPC F21V 21/00; A47G 33/10; F21W 2121/04

(57) ABSTRACT

A Christmas/pine tree lights hanger tool is provided, comprising of a hollow, core tube which slides over the top, center branch of a said tree. This tube is inserted snuggly into the hub member opening, surrounded by a plurality of “wheel-like” spokes, in which pie shaped spaces are incorporated on each side of said spokes, allowing surrounding top tree branches to naturally protrude up through. Said spokes connect at the distal end to an outer circular support rim, comprising of a plurality of “T” shaped hooks on the top side. These hooks, evenly spaced and purposed to hold universal Christmas light strands, drape down, encircling the body of said tree from top to bottom. A tree topper can be placed over the top of the core tube. If corded, the cord is fed down through the tube, down alongside the trunk, where it is plugged into a nearby outlet.

### CLASSIFICATIONS

A47G33/10—Fastening devices or clamps for Christmas tree decorations
A47G2033/0827—Christmas tree decorations illuminated
A47G2033/089—Christmas tree decorations for the upper extremity of the central stem
A47G33/0863—Elongated flexible decorations e.g., tinsels, garlands, chains
F21V21/00—Supporting suspending or attaching arrangements for lighting devices; hand grips
F21V21/08—Devices for easy attachment to any desired place, e.g., clip, clamp, magnet
F21S4/10—Lighting devices or systems using string or strip of light sources with light sources attached to loose electric cables, e.g., Christmas tree lights
F21W2121/04—Use or application of lighting devices or systems for decorative purposes, not provided for in codes F21W2102/OO—F21W2107/OO for Christmas trees

### RELATED APPLICATION

US20180042421A1 Christmas tree lights hanger, filed 2017-03-26 (ABANDONED)

### FIELD OF INVENTION

The present invention relates to decorating accessories for lights, but more closely to a Christmas tree lights hanger tool. While there is another type of tree lights hanger known, there is a need for a tree lights hanger tool that keeps light strands from overlapping and becoming entangled, provides sufficient support and balance to the tree from the top and bottom sides of the tree lights hanger, offers a sufficient number of hooks that will not lift off, provides room for a cord to hang down through the tube when using a powered tree topper and is more discreet, therefore not distracting from the beauty of the tree.

### BACKGROUND OF INVENTION

Applying light strands to artificial Christmas trees or real outdoor pine trees is commonly known as an unpleasant chore during the holidays. The process can generally take a few hours and can cause the decorator's hands to be red and irritated from reaching within prickly branches. It is especially challenging when trying to replace burned-out strands on a pre-lit, artificial tree. On a pre-lit artificial tree, the difficulty comes when attempting to replicate the path of the lights as the manufacturer originally attached them. It is a known occurrence that some decorators will throw out an entire artificial, pre-lit tree in order to start out with new lights.

Of the known tree lights hanger tool, there are several rows of teeth on each said spoke in which to hook light strands. The problem with this design is that multiple strands of lights must be draped over top of each other, causing light strands to become stacked and entangled on the areas below the hanger, as well as creating added weight and stress to the branches.

The top cone shaped section of the known tree light hanger is not adjustable, provides no support below the hanger and would require a tree topper decoration in order to disguise the top cone shaped portion of the hanger that sticks up, well above the top center branch.

The current lights hanger tool invention can be used with universal brands of light strands on any real or artificial Christmas/pine style tree. When using the current invention, the whole tree is covered evenly with lights. The strands are easy to locate when replacing a burned-out strand, which reduces the hassle and frustration that creates the desire to discard a perfectly useable artificial tree.

During the process of applying light strands the lights hanger tool becomes unbalanced before all strands are evenly applied. Due to the design of the “T”-shaped hooks, the light strands will not lift off during the application process. They are easy to hook on, they are evenly spaced and are equally easy to remove by simply lifting the strands up off the hooks. The current lights hanger tool saves time, money and unwanted aggravation. It also provides a balanced platform for a powered or non-powered tree topper to rest. Of the current invention, the center tube is adjustable by sliding it up or down. If no tree topper is used, the center tube can be slid down to become flush with the hub of spokes, making it less visible. The open triangular shaped spaces in between the spokes allow surrounding, top tree branches to stick up naturally, preventing them from becoming flattened or broken when the lights hanger tool is in use.

The current invention of a lights hanger tool is made of a solid plastic but is not limited to this material. It can be made in any color. It can be produced by 3-D printing or injection molding.

### BRIEF SUMMARY OF THE INVENTION

A Christmas tree lights hanger tool is provided, comprising of an adjustable, core, hollow tube that is inserted snuggly into the center hole of the hub member. The core, hollow tube is placed over the top, center branch of a Christmas/pine style tree. The hub member, comprising of plurality of spokes, connects to an outer circular support rim, which provides a plurality of evenly spaced “T” shaped hooks, located on the top side. The hooks are evenly spaced and encompass the entire outer circular support rim, providing enough lights coverage for any size tree. If less lights are desired, the decorator can skip hooks in an even pattern. The core hollow tube extends above and below the hub member, and adjusts by sliding. It provides stability to the center branch from the top and bottom areas of the tool. If a tree topper is used, it is placed over the top lip of the core hollow tube and rests on the “wheel-like” spokes providing balance to the tree topper as well. If the tree topper has an electrical cord, the cord is fed down through the tube and down alongside the center stem of said tree and plugged in to a nearby electrical receptacle.

Even though the present invention has been described in detail, it shall be inferred that the descriptions herein of the appended claims are not specifically limited to these features. Alternate variations may come to those skilled in the art, without exiting from the heart of the in invention.

### BRIEF DESCRIPTION OF DRAWINGS

FIG. 1 is a top perspective view of the current lights hanger tool according to the first preferred embodiment of the present invention.

FIG. 2 is a bottom perspective view of the lights hanger tool shown in FIG. 1.

FIG. 3 is a side view of the lights hanger tool shown in FIG. 1 wherein the light strands are draped over the “T” shaped hooks on the top side of the outer, circular support rim.

FIG. 4 is a side view of the lights hanger tool shown in FIG. 1 wherein the lights hanger tool is placed over the top, center branch of a Christmas/pine style tree, wherein branches are protruding up through the said triangular spaces, surrounding the inner spokes of the tree lights hanger tool.

FIG. 5 is a side view of the lights hanger tool shown in FIG. 1 wherein a lighted tree topper is placed over the core tube, wherein the electrical cord runs down the core tube and down alongside the center stem of a Christmas/pine style tree.

### DETAILED DESCRIPTION OF THE PREFERRED EMBODIMENT

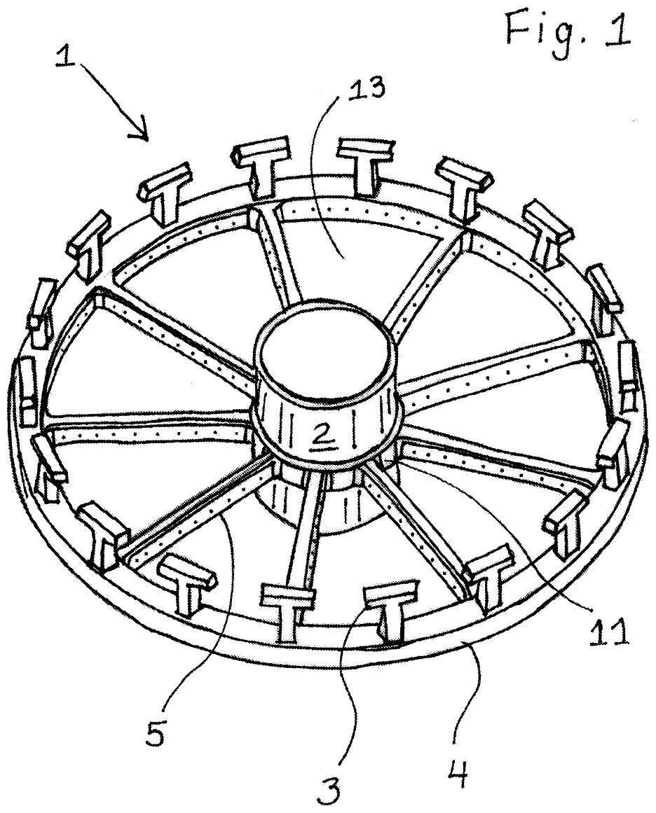

FIG. 1 is a top perspective view of the tree lights hanger tool according to a first preferred embodiment of the invention. Illustrated is a tree lights hanger tool 1 comprising of a core tube 2 which is inserted snuggly into the hub member 11 where it provides support above and below said hub member. The hub member is surrounded proximally by a plurality of “wheel-like” spokes 5 and open triangular spaces 13. At the distal end of said spokes and spaces is a circular, outer support rim 4 with a plurality of “T-shaped hooks 3 on the top side.

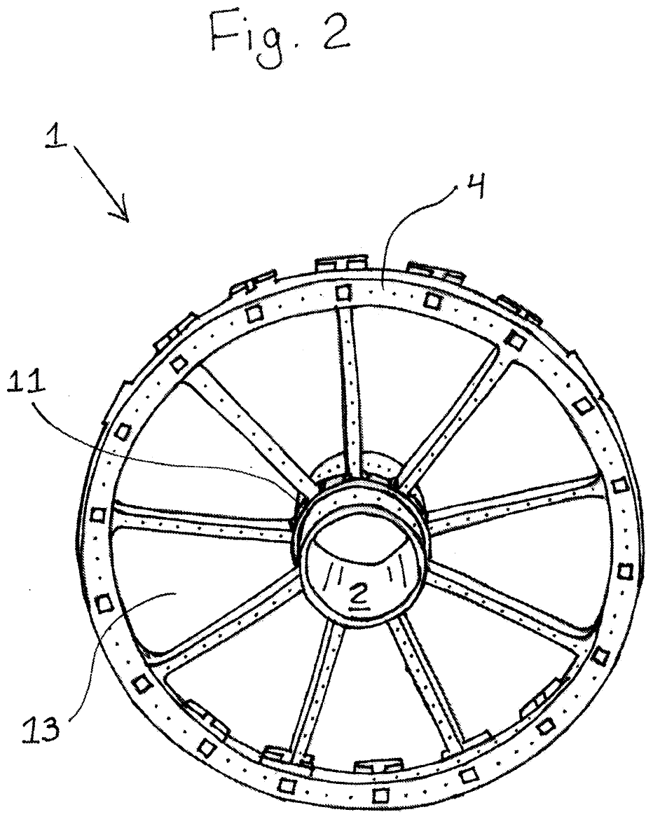

FIG. 2 illustrates the bottom perspective view of the tree lights hanger tool 1. The core hollow tube 2 is inserted snuggly into the hub member 11. “Wheel-like” spokes extend radially from the proximal end, surrounded by open triangular spaces 13 and connect to a flat-bottomed circular support rim 4.

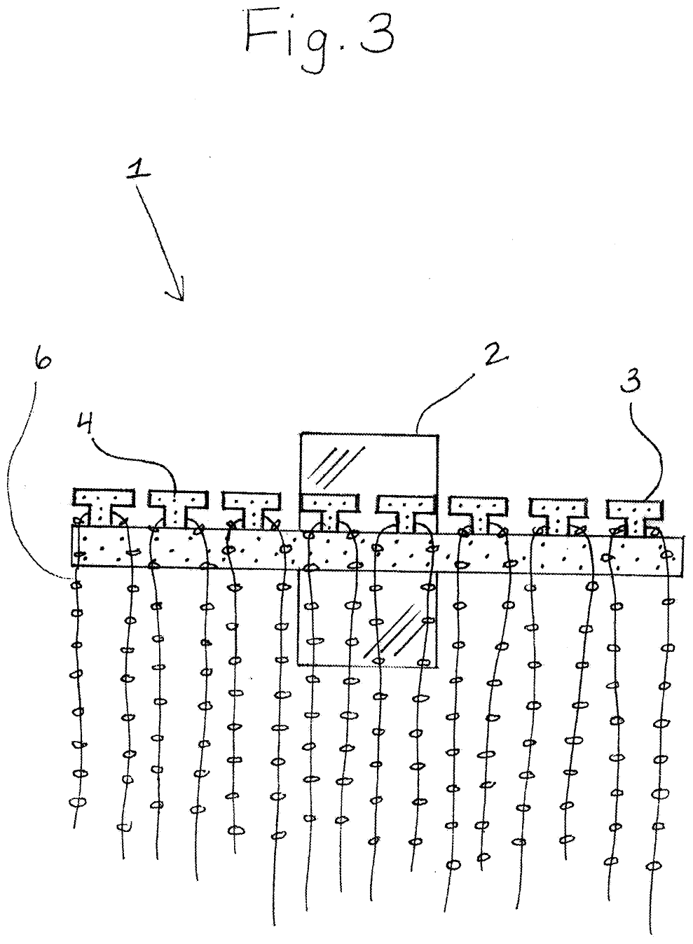

FIG. 3 is a side view of the tree lights hanger tool 1 comprising of a core, hollow tube 2, a plurality of “T” shaped hooks 3 located on the top side of the outer circular support 4. The hooks are evenly placed to receive universal strands of Christmas lights 6 which will hang down the length of a Christmas/pine style tree.

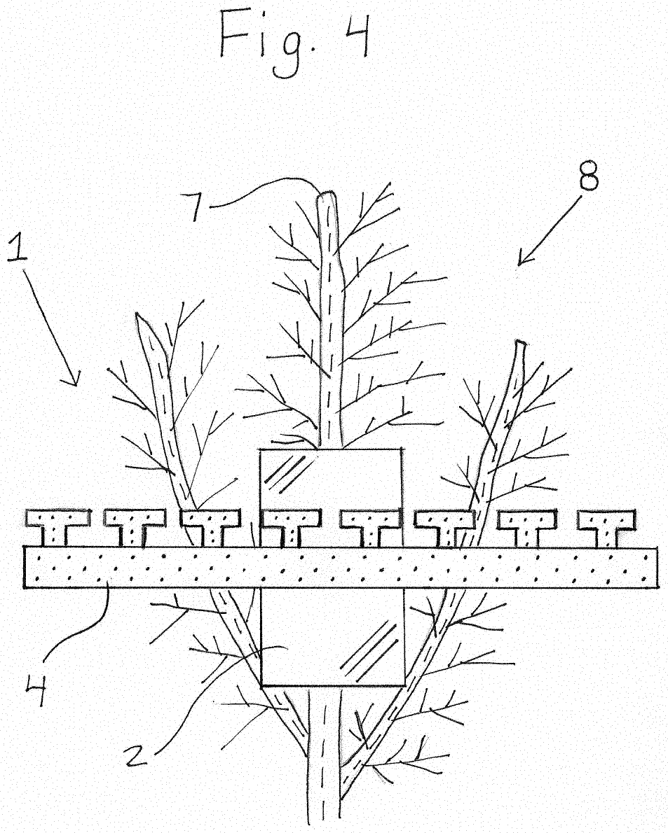

FIG. 4 is a side view of the tree lights hanger tool 1 wherein a core, hollow tube 2 is slid over the top center branch 7 of the Christmas/pine style tree. The top, surrounding tree branches 8 protrude naturally up through the open triangular spaces (not visible from the side view) that are within the outer circular support 4, preventing the branches from becoming flattened or damaged.

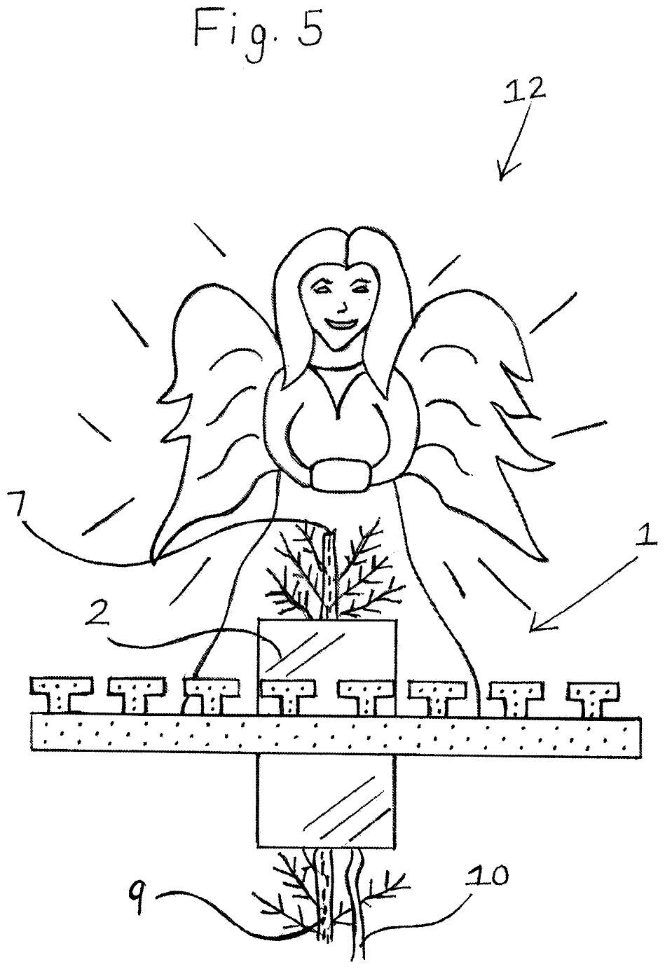

FIG. 5 is a side view illustrating a tree lights hanger tool 1 with a lighted tree topper 12. An angel is used as an example. The tree topper is placed over the top lip of the core, hollow tube 2 which is placed over the top center branch 7 of a Christmas/pine style tree. This illustration using a powered (lighted) tree topper, shows the electrical cord 10 from said tree topper hanging down through the core tube, where it will continue down the center stem 9 of said tree, to be plugged in to an electrical receptacle.

What is claimed is:

1. A tree lights hanger comprising: of a core hollow tube configured to be inserted snuggly within the center hole of the hub member, configured to extend above and below the hub member which is surrounded by a plurality of proximal and distal “wheel-like” spokes, wherein said spokes are surrounded by triangular open spaces, wherein the distal spokes connect to a circular support rim which contains a plurality of “T” shaped hooks on the top side of said circular support.

2. The tree lights hanger tool according to claim 1, wherein the center tube is inserted snuggly into the hub member, wherein said core tube is placed over the top center branch of a Christmas/pine style tree.

3. The tree lights hanger tool according to claim 2, wherein the plurality of “wheel-like” spokes are connected proximally to the hub member and surrounded by triangular, open spaces in which surrounding top tree branches protrude up through.

4. The tree lights hanger according to claim 3, wherein the plurality of spokes is connected to a circular support rim at the distal end, which contains “T” shaped hooks on the top side, wherein a strand of universal Christmas lights is draped over each hook to encircle a Christmas/pine style tree from top to bottom of said tree.

5. The tree lights hanger tool according to claim 1 wherein, the core tube of the lights hanger tool is placed over the top center branch of a Christmas/pine style tree, wherein a powered or non-powered Christmas tree topper is placed over the top lip of said tube and rests on the plurality of spokes, providing stability and balance.

6. The tree lights hanger tool according to claim 5 wherein, a corded tree topper is placed over the core, hollow tube that has been placed over the top center branch of a Christmas/pine style tree, wherein the cord of a powered tree topper is fed down through said tube and down alongside the base center branch of the Christmas/pine style tree, to be plugged in to a nearby outlet or extension cord.
